(19) United States
(12) Patent Application Publication
(10) Pub. No.: US 2002/0085539 A1
(43) Pub. Date: Jul. 4, 2002

(54) Internet phone interface card having sound function

(75) Inventor: Jae Ho Hyun, Seoul (KR)

Correspondence Address: McDERMONTT, WILL & EMERY, 600 13th Street, N.W., Washington, DC, 20005-3096, US

(73) Assignee: Commax, Inc.

(21) Appl. No.: 10/026,562

(22) Filed: Dec. 27, 2001

(30) Foreign Application Priority Data
Dec. 30, 2000 (KR) 87337/2000

(51) Int. Cl. H04J 3/16

(52) U.S. Cl. 370/352; 370/465

(57) ABSTRACT

In an Internet phone interface card having a sound function, an Internet phone interface card having a sound function including a telephone signal detector detecting a state change signal transmitted from a general telephone, a signal processing unit receiving a telephonic signal from the telephone connected to a LAN (Local Area Network) or the Internet and transmitting a telephonic signal having a sound level adjustable to listening of a user to the general telephone, a ring signal generator detecting a telephonic signal from the LAN or Internet, generating a ring signal and transmitting it to the general telephone, and a microprocessor controlling the each circuit unit is capable of always providing an optimum sound level to a user although it is connected to other external telephone and providing an optimum sound level to the user in telephonic communication even after using other sound functions by setting a user request sound level by performing telephonic communication with a general telephone or an Internet telephone.

### BACKGROUND OF THE INVENTION

1. Field of the Invention

The present invention relates to an Internet phone, and in particular to an Internet phone interface card having a sound function.

2. Description of the Prior Art

FIG. 1 is a block diagram illustrating a first embodiment of a network for an Internet phone according to the prior art, it is constructed with a PC (Personal Computer) 101 and an Internet phone 102 connected to a LAN (Local Area Network) or the Internet or a PSTN (Public Switched Telephone Network) through the PC 101. The PC 101 includes a LAN card 11 connected to the LAN or Internet and a sound card 12 connected to the Internet phone 102. The Internet phone 102 is connected to a microphone port and a speaker port of the sound card 12 and a communication port (for example, RS-232) of the PC 101. Herein, Internet phones (not shown) are connected to the LAN or Internet, and a general telephone (not shown) is connected to the PSTN.

Accordingly, a user using the Internet phone 102 according to the prior art can perform telephonic communicate with the other party using a general telephone or an Internet phone connected to the Internet.

First, when the Internet phone 102 is in an hook-off state in order to be connected to a general telephone, the Internet phone 102 is directly connected to a general telephone connected to the PSTN without passing through the PC 101.

In the meantime, in order to connect the Internet phone 101 to other Internet phones connected to the LAN or Internet, by pressing a certain button of the Internet phone 102, the Internet phone 101 is connected to the sound card 12 installed in the PC 101 through the microphone port and the speaker port of the sound card, the sound card 12 is connected to the other Internet phone through a LAN card of the PC 101, accordingly the Internet phone 101 is connected to the other Internet phone.

FIG. 2 is a block diagram illustrating a second embodiment of a network for an Internet phone according to the prior art, it is constructed with a PC 101 and Internet phones (not shown) connected to the LAN or Internet through the PC 101 or Internet phones 103 connected to the PSTN. Herein, the PC 101 includes a LAN card 11 connecting to the LAN or Internet. In addition, the Internet phone 103 includes a sound function unit 13 having a sound card function and is connected to the PC 101 through a USB port (not shown) of the PC 101.

The Internet phone according to the prior art receives/transmits audio streams from/to other Internet phones connected to the Internet through the USB port of the PC 101 based on a USB protocol.

Because the Internet phone 103 recognizes a received/transmitted sound level by using the sound function unit 13, it can solve a sound level adjustment problem of the Internet phone 102 in the prior art.

However, because the Internet phone according to the prior art is an outer packaging type, it has to be supplied additional power by being connected to a PC, for that, an additional power supply apparatus is required, accordingly circuit wiring is complicated and production cost is increased.

In addition, in order to connect the Internet phone according to the prior art to other Internet phones connected to the LAN or Internet, a sound card installed in the PC has to be used, a sound level of the Internet phone has to be adjusted in connecting to other telephone (for example, local call, toll call, overseas call, cellular phone call, etc.). Accordingly, whenever the Internet phone is connected to other Internet phone through the LAN or Internet, sound level of the Internet phone is adjusted appropriately so as to make users perform telephonic communication with appropriate sound level. In addition, because the PC has different sound levels in telephonic communication function and audio function, in order to perform an audio function, a sound function program has to be re-executed after performing the telephonic communication function. Accordingly, in the Internet phone according to the prior art, a telephonic communication quality can be largely varied according to sound level adjustment function, when the sound level can be largely adjusted for improvement of the telephonic communication quality, probability that collisions will occur with other application programs may increase.

In addition, in the Internet phone according to the prior art, because a sound function unit having functions same as the sound card installed in the PC has to be further included, production cost increases, and the Internet phone can connect to other Internet phones only through the Internet.

In addition, in the Internet phone according to the prior art, because it is connected to the PC on the basis of a USB standard, it has limitations in connecting distance, and when a plurality of equipment are connected to the PC, a telephonic communication quality is lowered.

### SUMMARY OF THE INVENTION

It is an object of the present invention to provide an Internet phone interface card having a sound function which is capable of providing an optimum sound level in telephonic communication by being connected to a general telephone or an Internet phone.

It is another object of the present invention to provide an Internet phone interface card having a sound card function and a sound function connectable to an Internet phone.

In order to achieve the above-mentioned objects, for communicating with a telephone connected to a LAN or the Internet, an Internet phone interface card having a sound function in accordance with the present invention includes a telephone signal detector detecting a state change signal transmitted from a general telephone in order to perform telephonic communication with a telephone connected to a LAN (Local Area Network) or the Internet, a signal processing unit receiving a telephonic signal from the telephone connected to the LAN or Internet and transmitting a telephonic signal having a sound level adjustable to listening of a user to the general telephone, a ring signal generator detecting a telephonic signal transmitted from the LAN or Internet, generating a ring signal and transmitting it to the general telephone, and a microprocessor controlling the each circuit unit.

### BRIEF DESCRIPTION OF THE DRAWINGS

FIG. 1 is a block diagram illustrating a first embodiment of a network for an Internet phone according to the prior art;

FIG. 2 is a block diagram illustrating a second embodiment of a network for an Internet phone according to the prior art; and

FIG. 3 is a block diagram illustrating a network connected to an Internet phone interface card having a sound function in accordance with the present invention.

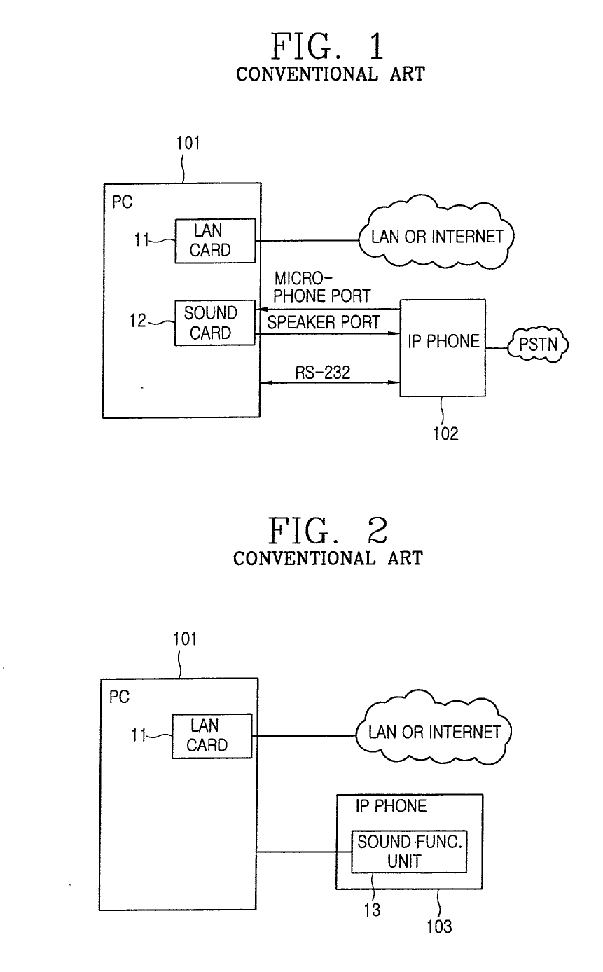

### DETAILED DESCRIPTION OF THE PREFERRED EMBODIMENT

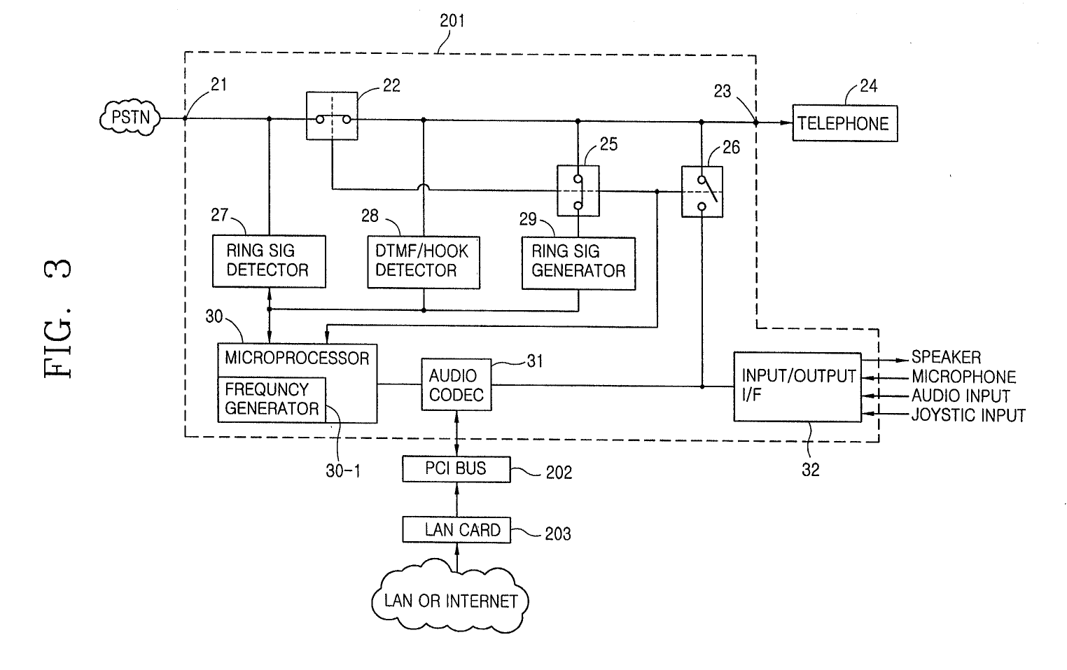

FIG. 3 is a block diagram illustrating a network connected to an Internet phone interface card having a sound function in accordance with the present invention. As depicted in FIG. 3, it comprises a PCI bus 202 of a certain computer (not shown) and a LAN (Local Area Network) card connecting the PCI bus 202 to a LAN (Local Area Network) or the Internet, and it is connected to a PSTN (Public Switched Telephone Network) or the LAN or Internet through the PCI bus 202 and a general telephone 24. Herein, the Internet phone interface card 201 having the sound function is connected to the PSTN through a first input/output port 21 and connected to the general telephone 24 through a second input/output port 23.

In order to make the Internet phone connected to the LAN or Internet perform telephonic communication with the general telephone 24 and a general telephone connected to the PSTN, the Internet phone interface card 201 having the sound function connected to external networks in accordance with the present invention includes a microprocessor 30 controlling each circuit unit, a ring signal detector 27 connected to the PSTN, detecting a call signal received from the PSTN and transmitting it to the microprocessor 30, a DTMF/Hook detector 28 detecting a button press or a hook on/off of the general telephone and transmitting it to the microprocessor 30, a ring signal generator 29 detecting a call signal received from the LAN or Internet through the microprocessor 30 and generating a ring signal in order to transmit a communication signal to the general telephone 24, an audio codec 31 processing an audio signal transmitted/received between Internet phones connected to the LAN or Internet through the general telephone 24 and the PCI bus 202 in accordance with the control of the microprocessor 30, an input/output interface unit 32 connected to the audio codec 31 and having a speaker output port, a microphone input port, an audio input port and a joy stick input port, a first switch 22 connecting a telephone connected to the PSTN with the general telephone 24 in accordance with the control of the microprocessor 30, a second switch 25 connecting the ring signal generator 29 with the general telephone for performing Internet telephonic communication in accordance with control of the microprocessor 30, and a third switch 32 connecting the general telephone 24 with the audio codec 31 and the input/output interface 32 in order to perform internet telephonic communication in accordance with the control of the microprocessor 30.

Herein, when the general telephone 24 is connected to a general telephone connected to the PSTN, in order to call the general telephone 24 through the Internet, the microprocessor 30 further includes a frequency generator 30-1 generating a signal having a certain frequency in order to generate a holding tone.

The switches 22, 25, 26 in accordance with the present invention use relay elements, and the first switch 22 and the second switch 25 are in the ON state.

The Internet phone interface card having the sound function in accordance with the present invention is installed at other PCI bus slot of the PC, and the operation will be described.

1) When power of the PC is in the off state

The Internet phone interface card having the sound function in accordance with the present invention does not actually operate, but the first switch 22 is in the on state, the general telephone 24 can perform telephonic communication with other general telephone.

2) When power of the PC is in the on state

(1) In calling of the general telephone 24

When the DTMF/Hook detector 28 detects the on/off state of the hook and press of a dial button of the general telephone 24 and transmits a detect signal to the microprocessor 30, the microprocessor 30 judges whether the detect signal is a signal for connecting the general telephone 24 to a general telephone connected to the PSTN or the Internet phone.

(1-a) Connecting the general telephone 24 to a general telephone connected to the PSTN

When the detect signal is a signal for connecting the general telephone 24 to a general telephone connected to the PSTN, the microprocessor 30 switches the switch 22 as the on state, accordingly the general telephone 24 can perform telephonic communication with the general telephone connected to the PSTN.

(1-b) Connecting the general telephone 24 to the Internet phone connected to the LAN or Internet

When the detect signal is a signal for connecting the general telephone 24 to the Internet phone, the microprocessor 30 switches the switch 22 as the off state and switches the switch 26 as the on state, accordingly the general telephone 24 can perform telephonic communication with an Internet phone through the audio codec 31.

(2) When a signal is received to the general telephone 24

(2-a) When a call signal is received from a general telephone connected to the PSTN

The ring signal detector 27 detects a ring signal received from the PSTN and transmits it to the microprocessor 30, the microprocessor 30 switches the switch 22 as the on state, accordingly the general telephone connected to the PSTN can perform telephonic communication with the general telephone 24.

(2-b) When a call signal is received from the Internet phone through the Internet

When the microprocessor 30 detects a call signal from the Internet phone, it controls the audio codec and the ring signal generator 29 and switches the switch 25 as the on state, the ring signal generator 29 transmits a ring signal to the general telephone 24 and generates a bell tone of the general telephone 24. Then, when the user picks up a tranceiver of the general telephone 24, the DTMF/Hook detector 28 detects the hook off state and transmits a signal indicating the hook off state to the microprocessor 30, and the microprocesor 30 switches the switch 26 as the on state, accordingly the general telephone 24 can perform telephonic communication with the internet phone through the audio codec 31.

(3) When the general telephone 24 receives a signal from the Internet phone while performing telephonic communication with a telephone connected to the PSTN

When the switch 22 is in the on state and the general telephone 24 performs telephonic communication with the telephone connected to the PSTN, the microprocessor 30 receives a call signal from the Internet phone, transmits a call signal to the general telephone 24 through the ring signal generator 25, when a user of the general telephone changes the hook state, the microprocessor 30 switches the switch 22 as the off state, transmits a holding tone to a general telephone connected to the PSTN by operating the frequency generator 30-1 and at the same time switches the switch 26 as the on state, accordingly the internet phone and the general telephone 24 can perform the telephonic communication.

After the telephonic communication with the Internet phone is ended, in order to reconnect the general telephone 24 to the general telephone connected to the PSTN (Public Switched Telephone Network) in the hold state, by changing the hook state again, the microprocessor 30 switches the switch 26 as the off state and switches the switch 25 as the on state, accordingly the general telephone 24 get backs in the original connection state (the general telephone 24 is reconnected to the general telephone).

(4) When a call signal is received from a telephone connected to the PSTN when the general telephone 24 performs the telephonic communication with the Internet phone

The ring signal detector 27 detects a call signal from a telephone connected to the PSTN and transmits a detect signal to the microprocessor 30, the microprocessor 30 transmits a ring signal to the general telephone 24 by controlling the ring signal generator 29. When a user of the general telephone 24 changes a state of the hook in a short time in order to hold the telephonic communication with a user of the preset connected Internet phone, the DTMF/hook detector 28 and the microprocessor 30 operate, a certain holding tone generated in the frequency generator 30-1 of the microprocessor 30 is transmitted to the user of the Internet phone through the audio codec 31, and at the same time the switch 26 is off and the switch 22 is on according to the control of the microprocessor 30, accordingly the general telephone 24 can perform the telephonic communication with the general telephone transmitting the call signal through the PSTN.

After finishing the telephonic communication with the telephone connected to the PSTN, in order to reconnect the general telephone 24 to the Internet phone in the hold state, the microprocessor 30 switches the switch 22 in the off state and switches the switch 26 in the on state by changing the state of the hook, accordingly the general telephone 24 is reconnected to the Internet phone.

In the meantime, the audio codec 31 of the Internet phone interface card 201 having the sound function performs the internet telephonic communication on the basis of a telephone interface card application program performed in the microprocessor 30, accordingly the general telephone 24 can receive/transmit audio signals with the internet phone connected to the LAN or Internet through the PCI bus 202. In addition, the audio codec 31 recognizing an optimum audio level sets the present set audio level as the optimum audio level for telephonic communication, when the telephonic communication is ended, the audio codec 31 resets the optimum audio level for the telephonic communication as the former audio level. In more detail, when the Internet phone is not used, the audio codec 31 performs a general sound function, accordingly the user can make the audio codec 31 reproduce a request music.

When the Internet phone interface card 201 having the sound function in accordance with the present invention is operated as the sound card, the audio codec 31 processes a signal inputted/outputted from a speaker output port, a microphone input port, an audio input port and a joy stick input port by interlocking With the input/output interface unit 32. For example, when a joy stick is used for a certain game, the input of the joy stick is recognized in the audio codec 31, is transmitted to the microprocessor of the PC, and the user enjoy the game by adjusting the joy stick.

In the Internet phone interface card having the sound function in accordance with the present invention, when a user request sound level is set by performing telephonic communication with the general telephone or the Internet phone at the early connection to the PC, it always provide an optimum sound level to a user although it is connected to other external telephone, and it can provide the optimum sound level to the user in telephonic communication even after using other sound functions.

In addition, the Internet telephone interface card having the sound function in accordance with the present invention is usable for both a general telephone connected to the PSTN or Internet phone connected to the LAN or Internet, a customer do not have to buy an additional telephone in order to perform telephonic communication with the Internet phone or the general phone.

What is claimed is:

1. An Internet phone interface card having a sound function, comprising:
a telephone signal detector detecting a state change signal transmitted from a general telephone in order to perform telephonic communication with a telephone connected to a LAN (Local Area Network) or the Internet;
a signal processing unit receiving a telephonic signal from the telephone connected to the LAN or Internet and transmitting a telephonic signal having a sound level adjustable to listening of a user to the general telephone;
a ring signal generator detecting a telephonic signal transmitted from the LAN or Internet, generating a ring signal and transmitting it to the general telephone; and
a microprocessor controlling the each circuit unit.

2. The Internet phone interface card of claim 1, wherein the state change signal is a signal corresponded to a DTMF signal generation state varied according to a hook on/off state of the general telephone or a dial press.

3. The Internet phone interface card of claim 1, wherein the signal processing unit includes:
an audio codec processing an audio signal transmitted/received to/from the telephone connected to the LAN or Internet according to the control of the microprocessor; and
an input/output interface unit connecting the audio codec to an input/output means of a user.

4. The Internet phone interface card of claim 3, wherein the audio codec automatically sets an optimum sound level in telephonic communication with an Internet phone or in performing of a general sound function by memorizing an audio level

5. The Internet phone interface card of claim 3, wherein the input/output means of the user includes a speaker, a microphone, an audio set and a joy stick.

6. The Internet phone interface card of claim 1, further comprising:
a ring signal detector detecting a ring signal received from a telephone connected to a PSTN (Public Switched Telephone Network) and transmitting the received ring signal to the microprocessor.

7. The Internet phone interface card of claim 6, further comprising:
a first switch switching off the connection between two telephones and switching on again according to the control of the microprocessor when the ring signal detector detects a call signal transmitted from the PSTN and transmits the detected call signal to the microprocessor in telephonic communication between a general telephone and a telephone connected to the LAN or Internet; and
a third switch switching on the connection between the two telephones and switching off again.

8. The Internet phone interface card of claim 6, further comprising:
a second switch transmitting or suspending transmission of the ring signal from the ring signal generator to the general telephone according to the control of the microprocessor when the microprocessor detects a signal received from the telephone connected to the LAN or Internet and outputs the detected signal to the ring signal generator and the ring signal generator generates a ring signal in telephonic communication between the general telephone and the telephone connected to the PSTN.

9. The Internet phone interface card of claim 6, wherein the microprocessor further includes:
a frequency generator transmitting a holding tone to the present communicating telephone in order to connect the general telephone to another telephone transmitting a call signal.
